(19) United States
(12) Patent Application Publication
(10) Pub. No.: US 2025/0193094 A1
(43) Pub. Date: Jun. 12, 2025

(54) TIME SINCE FAILURE INFORMATION IN CONNECTION ESTABLISHMENT FAILURE (CEF) REPORT LIST

(71) Applicant: Telefonaktiebolaget LM Ericsson (publ), Stockholm (SE)

(72) Inventors: Sakib BIN REDHWAN, Linköping (SE); Ali PARICHEHREHTEROUJENI, Linköping (SE); Marco BELLESCHI, Solna (SE)

(21) Appl. No.: 18/842,301

(22) PCT Filed: Mar. 31, 2023
(86) PCT No.: PCT/IB2023/053260

§ 371 Date: Aug. 28, 2024

Related U.S. Application Data
(60) Provisional application No. 63/326,468, filed on Apr. 1, 2022.

(51) Int. Cl. H04L 43/04; H04L 43/06; H04L 43/0811; H04W 24/08

(52) U.S. Cl. CPC H04L 43/04; H04L 43/06; H04L 43/0811; H04W 24/08

(57) ABSTRACT

A method performed in a UE includes observing a first connection establishment failure, CEF, of a connection establishment procedure; logging standardized information into an entry associated to the first CEF in a CEF report list; starting a first timer associated with the first CEF; observing one or more additional CEFs of the connection establishment procedure; logging standardized information into one or more entries in the CEF report list, each of the entries uniquely associated with the one or more additional CEFs; starting one or more additional timers, each of the one or more additional timers uniquely associated with a different one of additional CEFs; receiving a request from a network node to provide a CEF report; and responsive to receiving the request: stopping the first timer and the one or more additional timers; and transmitting the CEF report and the CEF report list to the network node.

### TECHNICAL FIELD

The present disclosure relates generally to communications, and more particularly to communication methods and related devices and nodes supporting CEF reports.

### BACKGROUND

Connection Establishment Failure (CEF) Report

The user equipment (UE) logs failed radio resource control (RRC) connection establishments for long term evolution (LTE), universal mobile telecommunications system

(UMTS) and new radio (NR). A log is created when the RRC connection establishment procedure fails. For NR, the UE logs any failed connection establishment attempt, i.e., a log is created when the RRC setup or resume procedure fails. The UE logs failed RRC connection establishments without the need for prior configuration by the network.

The UE stores the selected PLMN (public land mobile network) on the RRC connection establishment failure or RRC resume procedure failure. Only if that PLMN is the same as the registered PLMN (RPLMN), the UE may report the log.

The trigger for creating a log related to a failed RRC connection establishment is for NR when timer T300 expires, for LTE when timer T300 expires and for UMTS when V300 is greater than N300. The trigger for creating log related to a failed RRC resume procedure is for

NR when timer T319 expires.

Further description of the CEF report can be found in the 3rd Generation Partnership Project (3GPP) technical specification (TS) 37.320.

The CEF report is stored in the UE using the variable VarConnEstFailReport.

### VarConnEstFailReport

The UE variable VarConnEstFailReportList includes a list of the connection establishment failure information and/or connection resume failure information.

### VarConnEstFailReport UE Variable

```
-- ASN1START
-- TAG-VARCONNESTFAILREPORT-START
VarConnEstFailReport-r16 ::= SEQUENCE {
  connEstFailReport-r16 ,
  plmn-Identity-r16 PLMN-Identity
}
-- TAG-VARCONNESTFAILREPORT-STOP
-- ASN1STOP
```

The ConnEstFailReport information element (IE) is defined as:

| ConnEstFailReport-r16 ::= | SEQUENCE { | |
|---|---|---|
| measResultFailedCell-r16 | , | |
| locationInfo-r16 | OPTIONAL, | |
| measResultNeighCells-r16 | SEQUENCE { | |
| measResultNeighCellListNR | MeasResultList2NR-r16 | OPTIONAL, |
| measResultNeighCellListEUTRA | MeasResultList2EUTRA-r16 | OPTIONAL |

},

| | |
|---|---|
| numberOfConnFail-r16 | INTEGER (1..8), |
| perRAInfoList-r16 | , |
| timeSinceFailure-r16 | , |

...
}

The UE sends the CEF report to network upon a specific request. The relevant excerpt from 3GPP TS 38.331 is:
1> if connEstFailReportReq is set to true and the UE has connection establishment failure or connection resume failure information in VarConnEstFailReport and if the RPLMN is equal to plmn-Identity stored in VarConnEstFailReport:
   2> set timeSinceFailure in VarConnEstFailReport to the time that elapsed since the last connection establishment failure or connection resume failure in NR;
   2> set the connEstFailReport in the UEInformationResponse message to the value of connEstFailReport in VarConnEstFailReport;
   2> discard the connEstFailReport from VarConnEstFailReport upon successful delivery of the UEInformationResponse message confirmed by lower layers;

It is apparent that the TimeSinceFailure IE is a mandatory IE and if the UE populates a CEF report, the UE adds the TimeSinceFailure IE during reporting towards the network.

Further details of the procedure of generating and reporting can be found in TS 38.331.

### Current Progress in 3GPP

In 3GPP, it was discussed that UE would log and report a list of CEF reports to the network. The following agreements were reached:
1. Multiple CEF reports is introduced to solve the problem about UL/DL coverage imbalance. For future study (FFS) is whether UE capability is applied. FFS is how to limit the overhead during running CR.
2. Only one PLMN is allowed in multiple CEF reports and the UE clears stored connection establishment/resume failure information upon logging a CEF report in a cell with a different RPLMN identity.
3. PerRAInfoList is included in CEF report when multiple CEF is stored.
4. Existing availability bit and request bit is reused for multiple CEF reports.
5. When the UE occurs a new CEF, if the failed cell id of the CEF is the same as the failed cell id in the last entry in VarConnEstFailReportList, the UE replaces the last CEF report with the new CEF report and the numberOfConnFail is summed. Otherwise (two cell ids are different), the UE appends the new CEF into VarConnEstFailReportList.

Furthermore, in the ongoing change request (CR) work of TS 38.331 [3], the following was added in section 5.3.3:
2> if the UE supports multiple CEF report:
   3> if the cgi-Info in the measResultFailedCell in the newly added VarConnEstFailReport is the same as the cgi-Info in the measResultFailedCell in the last entry in the VarConnEstFailReportList:
      4> except for the numberOfConnFail, replace all information elements for the enty with the VarConnEstFailReport:
   3> else:
      4> if the maxCEFReport-r17 has not been reached:
         5> append the VarConnEstFailReport as a new entry in the VarConnEstFailReportList.

Similar to the CEF report, a new variable, VarConnEstFailReportList has been introduced where the UE would store the list of CEF reports. However, each element of VarConnEstFailReportList is the legacy VarConnEstFailReport.

### VarConnEstFailReportList

The UE variable VarConnEstFailReportList includes a list of the connection establishment failure and/or connection resume failure information.

### VarConnEstFailReportList UE Variable

-- ASN1START
-- TAG-VARCONNESTFAILREPORTLIST-START
VarConnEstFailReportLIST-r17 ::= SEQUENCE {
connEstFailReportList-r17 SEQUENCE (SIZE (1..maxCEFReport-r17)) OF
VarConnEstFailReport-r16
}
-- TAG-VARCONNESTFAILREPORTLIST-STOP
-- ASN1STOP

### SUMMARY

There currently exist certain challenge(s). In the structure of ConnEstFailReport, the variable timeSinceFailure is a mandatory parameter that the UE needs to add while reporting the CEF report to the network. Since each element of ConnEstFailReportList is a legacy ConnEstFailReport, the UE needs to add timeSinceFailure information to each of the elements. However, according to the current specification, the UE would include the time SinceFailure only for the last experienced failure.

Certain aspects of the disclosure and their embodiments may provide solutions to these or other challenges. According to some embodiments, a method in a user equipment, UE, includes observing a first connection establishment failure, CEF, of a connection establishment procedure; logging standardized information into an entry associated to the first CEF in the CEF report list; starting a first timer associated with the first CEF; observing one or more additional CEFs of the connection establishment procedure; logging standardized information into one or more entries in the CEF report list, each of the one or more entries uniquely associated with the one or more additional CEFs; starting one or more additional timers, each of the one or more additional timers uniquely associated with a different one of the one or more additional CEFs; receiving a request from a network node to provide a CEF report; and responsive to receiving the request: stopping the first timer and the one or more additional timers; and transmitting the CEF report and the CEF report list to the network node.

Certain embodiments may provide one or more of the following technical advantage(s). The various embodiments solve one of the drawbacks of current specifications. Since the timeSinceFailure field is mandatory, leaving the field undefined may bring discrepancies in the reported value. The various embodiments provide multiple options to populate time information. One of the various embodiments can provide maximum information to the network. A different embodiment can provide efficient re-use of a single timer variable which demands minimal memory and computational requirement from the UE.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is an illustration of a method where a single timer is used in the UE irrespective of the number of connection establishment failures experienced according to some embodiments;

FIGS. 2A and 2B is a flowchart illustrating operations of a user equipment illustrating options according to some embodiments;

FIG. 3 is an illustration of a method where multiple timers are in the UE used for each connection establishment failure experienced according to some embodiments;

FIGS. 4-14 are flow charts illustrating operations of a user equipment according to some embodiments;

FIG. 15 is a block diagram of a communication system in accordance with some embodiments;

FIG. 16 is a block diagram of a user equipment in accordance with some embodiments;

FIG. 17 is a block diagram of a network node in accordance with some embodiments;

FIG. 18 is a block diagram of a host computer communicating with a user equipment in accordance with some embodiments;

FIG. 19 is a block diagram of a virtualization environment in accordance with some embodiments; and

FIG. 20 is a block diagram of a host computer communicating via a base station with a user equipment over a partially wireless connection in accordance with some embodiments in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

As previously indicated, the variable timeSinceFailure is a mandatory parameter that the UE needs to add while reporting the CEF report to the network. Since each element of ConnEstFailReportList is a legacy ConnEstFailReport, the UE needs to add timeSinceFailure information to each of the elements. However, according to the current specification, the UE would include the timeSinceFailure only for the last experienced failure.

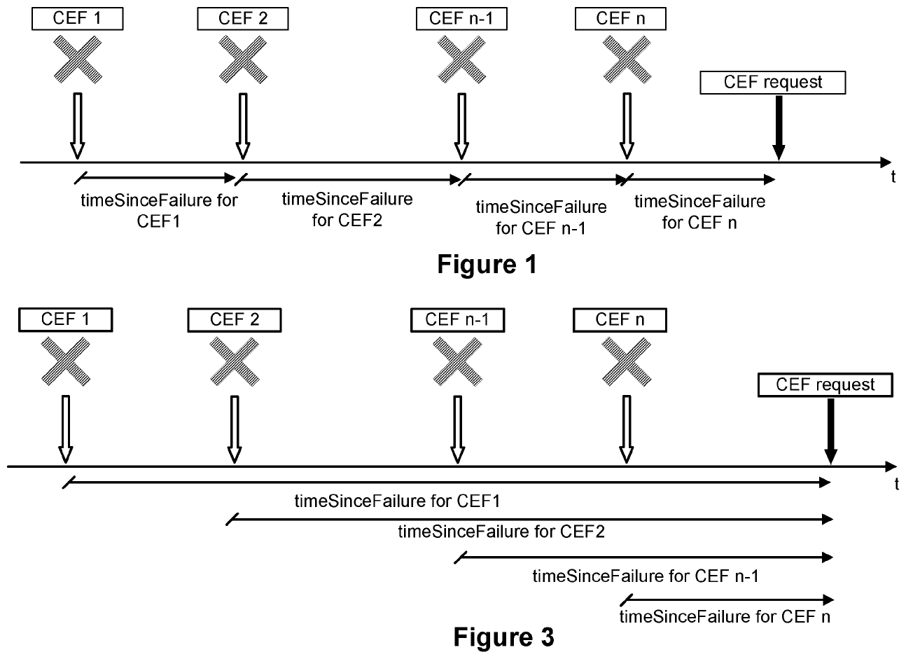

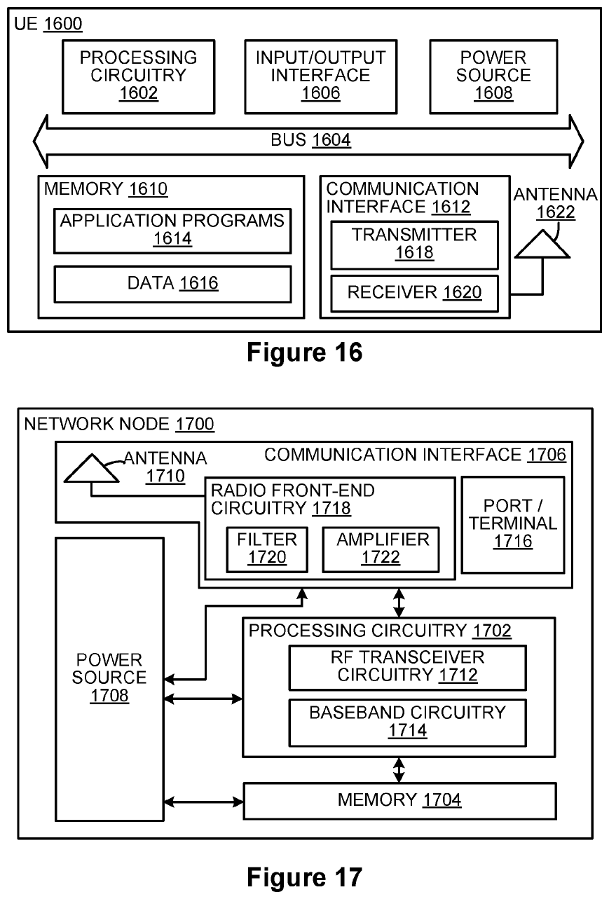

Operations of the user equipment 1600 (implemented using the structure of the block diagram of FIG. 16) will now be discussed with reference to the signaling diagrams and flow charts of FIGS. 1A, 1B to 14 according to some embodiments. For example, modules may be stored in memory 1610 of FIG. 16, and these modules may provide instructions so that when the instructions of a module are executed by respective UE processing circuitry 1602, the UE 1600 performs respective operations of the flow chart.

In some embodiments, a method performed in the User Equipment (UE) in which the UE logs the field timeSinceFailure for each experienced connection establishment failure, wherein each logged timeSince Failure in one entry of the connection establishment failure report list (e.g., connEstFailReportList), except the last (i.e., most recent) logged one, represents the time elapsed between consecutive connection establishment failures, i.e. between consecutive entries of the connEstFailReportList, and wherein the last logged timeSinceFailure represents the time elapsed between the last connection establishment failure and the point in time in which the UE transmits the list of connection establishment failure reports ConnEstFailReportList to the network. Hence in this method, the UE only maintains running one single timer irrespective of the number of failures included in the connection establishment failure report (ConnEstFailReport).

FIG. 1 illustrates the approach taken in these embodiments where a single timer is used. As illustrated in FIG. 1, after the first connection establishment failure (CEF), CEF 1, the timer t is started. When CEF 2 occurs, the timer t is reset and restarted. This process occurs after each CEF up to the point of a CEF request from the network where the timer t is stopped.

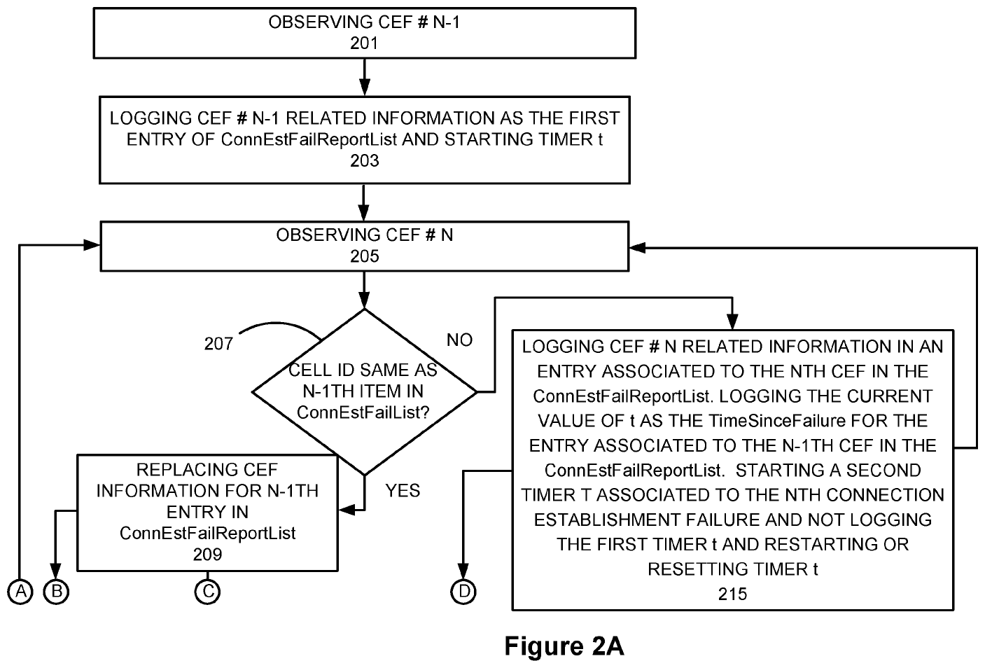

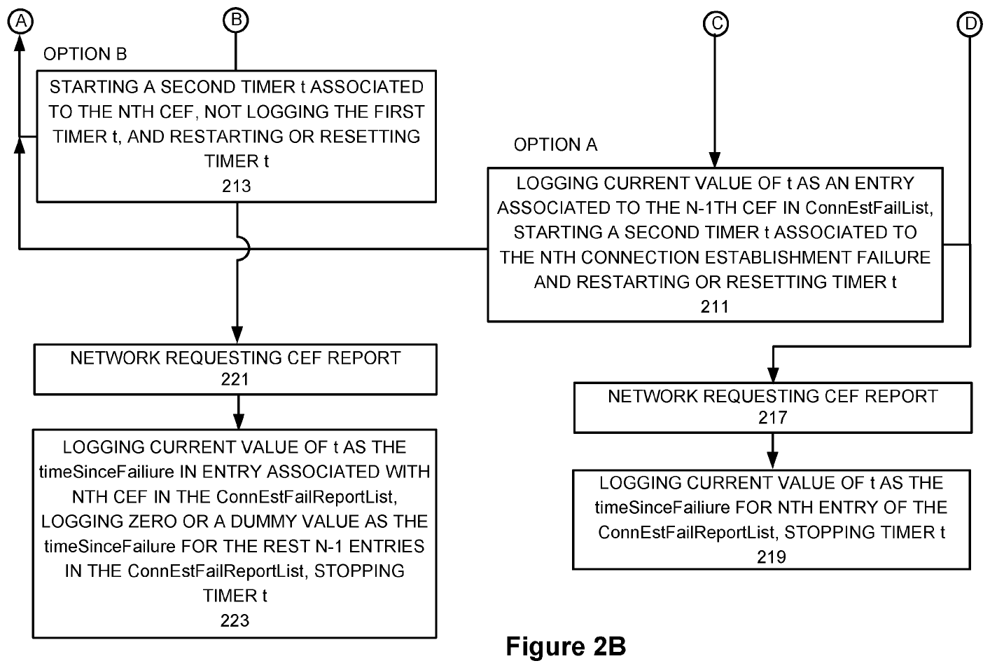

FIGS. 2A and 2B illustrate the overall approach and the various options that can be performed by the UE. Turning to FIG. 2A, in block 201, the UE 1600 observes a n−1 th connection establishment procedure being failed. In block 203, the UE 1600 logs standardized information into an entry associated to the n−1th CEF in the ConnEstFailReportList and starts a first timer t associated to the n−1 th connection establishment failure.

In block 205, the UE 1600 observes a n th connection establishment procedure being failed. In block 207, the UE 1600 determines if the cell id for the cell where n th failure occurred and the cell where the n−1 th failure occurred are the same.

If the cell ids are the same, the approach proceeds to block 209, where the UE 1600 replaces CEF information for an entry associated to the n−1 th entry in the ConnEstFailReportList with the information associated to the n th CEF:

From block 209, the UE 1600 may proceed to option a in block 211 or option b in block 213. In option a (block 211): the UE logs the current value of t in an entry associated to the n−1 th item of ConnEstFailReportList, and starts a second timer t associated to the n th CEF. This option can be for example implemented by the UE implementation by resetting the timer t associated to the n−1 th connection establishment failure and restarting/resetting it for the associated n th connection establishment failure.

In option b (block 213): the UE 1600 start a second timer t associated to the n th CEF, and does not log the first timer t, e.g., in some embodiments the UE 1600 stops and discards the first timer t. This option can be for example implemented by the UE implementation in other embodiments by resetting the timer t associated to the n−1 th connection establishment failure, and restarting it for the associated n th connection establishment failure.

Returning to block 207, if the cell id for the cell where n th failure occurred and the cell where the n−1 th failure occurred are different, the UE 1600 proceeds to block 215.

In block 215, the UE 1600 logs and appends CEF #n related information in an entry associated to the n th CEF in the ConnEstFailReportList, logs the current value of the timer t as the time since failure in the entry associated to the n−1 th CEF in the ConnEstFailReportList, and starts a second timer t associated to the n th connection establishment failure. This option can be for example implemented by the UE implementation by resetting the timer t associated to the n−1 th connection establishment failure and restarting it for the associated to the n th connection establishment failure.

Blocks 205-215 may be repeated for each experienced failure. These blocks are repeated until a network request to transmit the connection establishment failure report is received.

In blocks 217 and 221, the UE 1600 receives a request from the network to provide a connection establishment failure report.

In block 219, the UE 1600 stops the timer t associated to the last (i.e., most recent) CEF included in ConnEstFailReportList. The UE 1600 also updates the last entry of the ConnEstFailReportList with the current value of timer t and reports to the network.

In some embodiments, block 223 is performed. In block 223, the UE 1600 updates the entry associated to the n th element of the ConnEstFailReportList with the respective value of timer t and the rest n−1 th entries with a dummy value for the timer field within each entry and reports to the network. The dummy value can be 0. Alternatively, the UE 1600 updates each entry in the ConnEstFailReportList with the value of timer t and reports to the network.

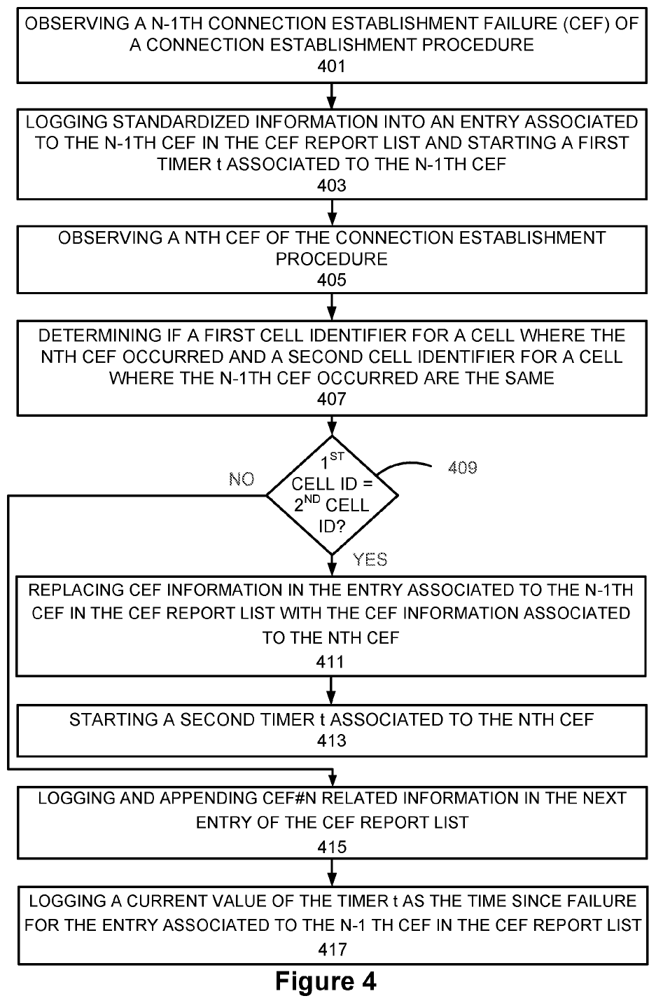

FIGS. 4-8 illustrate operations that the UE 1600 performs in some embodiments. Turning to FIG. 4, in block 401, the UE 1600 observes a n−1th connection establishment failure (CEF) of a connection establishment procedure. In block 403, the UE 1600 logs standardized information into an entry associated to the n−1th CEF in the CEF report list and starts a first timer t associated to the n−1th CEF.

In block 405, the UE 1600 observes a nth CEF of the connection establishment procedure. In block 407, the UE 1600 determines if a first cell identifier for a cell where the nth CEF occurred and a second cell identifier for a cell where the n−1th CEF occurred are the same.

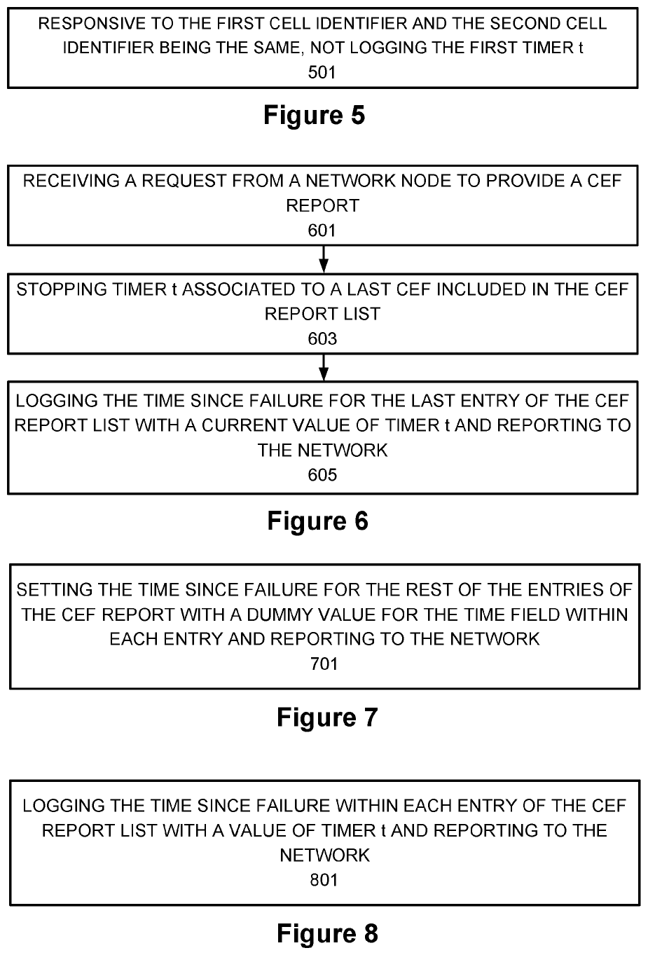

Responsive to the first cell identifier and the second cell identifier being the same (in block 409), the UE 1600 in block 411 replaces CEF information in the entry associated to the n−1th CEF in the CEF report list with the CEF information associated to the nth CEF. In block 413, the UE 1600 starts a second timer t associated to the nth CEF. In some embodiments, the UE 1600 starts the second timer by comprises resetting a timer t associated to the n−1 th connection establishment failure and restarting the timer t for the associated n th connection establishment failure Resetting the timer t in some embodiments is setting the timer t to zero. This approach results in one timer being used. In some of these embodiments, as illustrated in block 501 of FIG. 5, the UE 1600 does not log the first timer t.

Responsive to the first cell identifier and the second cell identifier is not the same (in block 409), the UE 1600 in block 415, logs and appends CEF #n related information in the next entry of the CEF report list. In block 417, the UE 1600 logs a current value of the timer t as the time since failure for the entry associated to the n−1 th CEF in the CEF report list. In some of these embodiments, the UE1600 starts a second timer t associated to the n th connection establishment failure. In some embodiments, the UE 1600 starts the second timer by comprises resetting a timer t associated to the n−1 th connection establishment failure and restarting the timer t for the associated n th connection establishment failure. The timer t is reset to zero in some embodiments.

FIG. 6 illustrates embodiments where the UE 1600 receives a request for a CEF report. Turning to FIG. 6, in block 601, the UE 1600 receives a request from a network node 1700 to provide a CEF report. In block 603, the UE 1600 stops timer t associated to a last (e.g., most recent) CEF included in the CEF report list.

In block 605, the UE 1600 logs the time since failure for the last (e.g., most recent) entry of the CEF report list with a current value of timer t and reports to the network. In some embodiments as illustrated in block 701 of FIG. 7, the UE 1600 sets the time since failure for the rest of the entries of the CEF report list with a dummy value (e.g., a zero value) for the time field within each entry and reports to the network. In other embodiments as illustrated in block 801 of FIG. 8, the UE 1600 logs the time since failure within each entry of the CEF report list with a value of timer t and reporting to the network.

In other various embodiments, a method is performed in the User Equipment (UE) in which the UE logs the field timeSinceFailure for each experienced connection establishment failure, wherein each logged timeSinceFailure in one entry of the connEstFailReportList, represents the time elapsed between the occurrence of the experience connection establishment failure and the point in time in which the network requests the UE to transmit the list of connection establishment failure reports (ConnEstFailReportList). Hence, in this method the UE maintains running at the same time multiple timers for each element of the ConnEstFailReportList IE.

The approach in these various embodiments is illustrated in FIG. 3 where a time since failure for each CEF of CEF 1, CEF 2, CEF n−1 and CEF n each have a timer associated with the CEF.

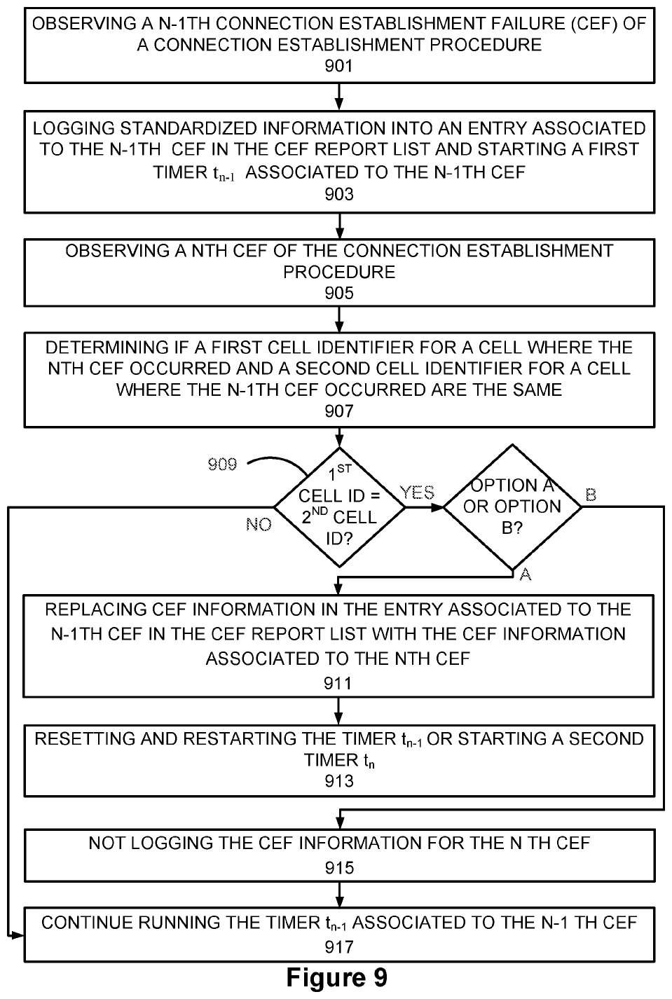

FIG. 9 illustrates operations the UE 1600 performs in these various embodiments.

Turning to FIG. 9, in block 901, the UE 1600 observes a n−1th connection establishment failure, CEF, of a connection establishment procedure. In block 903, the UE 1600 logs standardized information into an entry associated to the N−1th CEF in the CEF report list and starts a first timer tₙ₋₁ associated to the n−1th CEF.

In block 905, the UE 1600 observes a nth CEF of the connection establishment procedure. In block 907, the UE 1600 determines if a first cell identifier for a cell where the nth CEF occurred and a second cell identifier for a cell where the n−1th CEF occurred are the same.

Responsive to the first cell identifier and the second cell identifier being the same and an option A is used as determined in block 909:

In block 911, the UE 1600 replaces CEF information in the entry associated to the n−1th CEF in the CEF report list with the CEF information associated to the nth CEF. In block 913, the UE 1600 performs (913) one of resetting and restarting the timer tₙ₋₁ or starting a second timer tₙ.

Responsive (909) to the first cell identifier and the second cell identifier being the same and an option B is used:

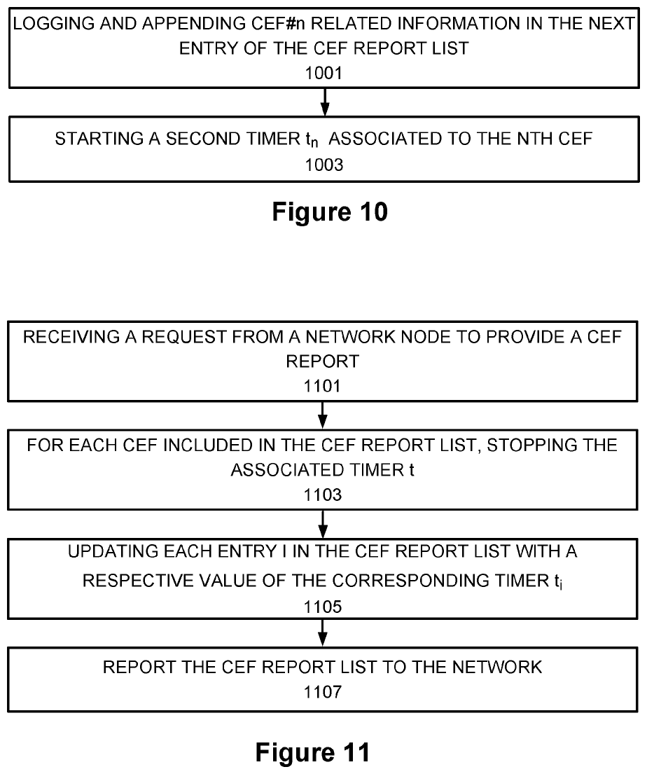

In block 915, the UE 1600 does not log the CEF information for the Nth CEF. In block 917, the UE 1600 continues to run the timer tₙ₋₁ associated to the n−1 th item of the CEF. Responsive to the first cell identifier and the second cell identifier not being the same, the UE 1600 also continues (as in block 917) running the timer tₙ₋₁ associated to the n−1 th CEF. Additionally, as illustrated in FIG. 10, the UE 1600 in block 1001 logs and appends CEF #n related information in the next entry of the CEF report list. In block 1003, the UE 1600 starts a second timer tₙ associated to the nth CEF.

The UE 1600 repeats blocks 905 to 917 and 1001 to 1003 for each experienced failure until a request for a CEF report is received.

FIG. 11 illustrates the UE 1600 receiving such a request. Turning to FIG. 11, in block 1101, the UE 1600 receives a request from a network node 1700 to provide a CEF report. In block 1103, the UE 1600, for each CEF included in the CEF report list, stops the associated timer t. In other words, the UE 1600 stops timer t₁, t₂, . . . tₙ₋₁, tₙ.

In block 1105, the UE 1600 updates each entry i in the CEF report list with a respective value of the corresponding timer tᵢ. In block 1107, the UE 1600 reports the CEF report to the network.

In other various embodiments, a method is performed in the User Equipment (UE) in which the UE logs the field timeSinceFailure for each experienced connection establishment failure, wherein the logged timeSinceFailure in the last/latest entry of the connEstFailReportList, represents the time elapsed between the occurrence of the connection establishment failure and the point in time in which the network requests the UE to transmit the list of connection establishment failure reports ConnEstFailReportList. Hence in this method, the UE only maintains running one single timer irrespective of the number of failures included in the ConnEstFailReport.

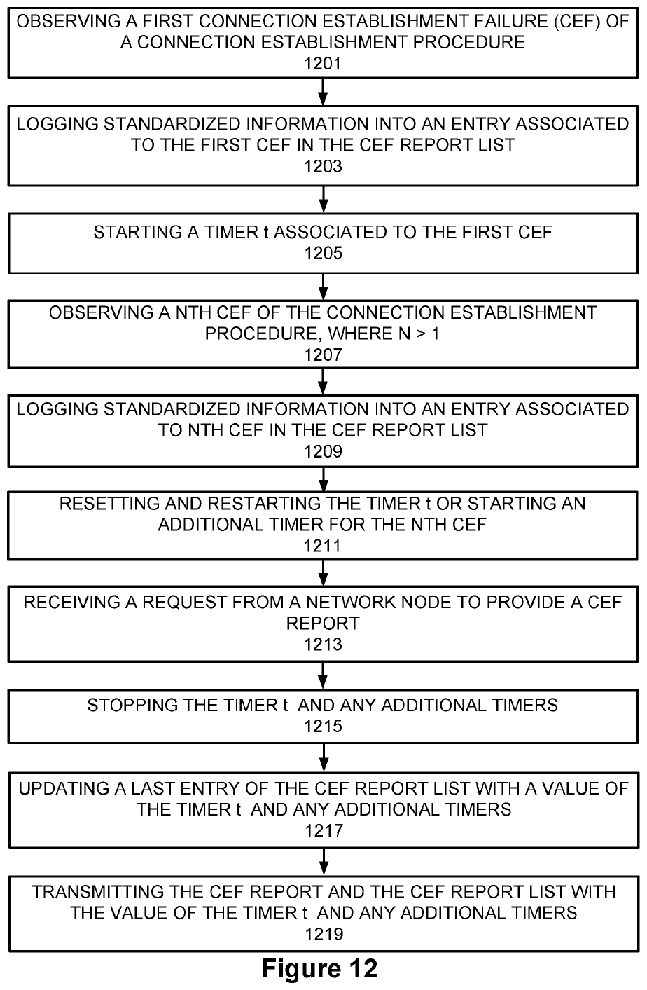

FIG. 12 illustrates operations the UE 1600 performs in these various embodiments. Turning to FIG. 12, in block 1201, the UE 1600 observes a first connection establishment failure, CEF, of a connection establishment procedure. In block 1203, the UE 1600 logs standardized information into an entry associated to the first CEF in the CEF report list and in block 1205, starts a timer t associated to the first CEF.

In block 1207, the UE 1600 observes a nth CEF of the connection establishment procedure where n is greater than one. In other words, the UE 1600 observes one or more additional CEFs of the connection establishment procedure. In block 1209, the UE 1600 logs standardized information into the CEF report list and in block 1211, resets and restarts the timer t or starts an additional timer for each of the additional CEFs. In some embodiments the UE 1600 resets the timer t by setting timer t to a zero value.

In block 1213, the UE 1600 receives a request from a network node 1700 to provide a CEF report. Responsive to receiving the request, the UE 1600 performs operations 1215-1219. In block 1215, the UE 1600 stops the first time and any additional timers (e.g., the one or more additional timers of the one or more additional CEFs.). In block 1217, the UE 1600 updates a last entry of the CEF report list with a value of the first time and the one or more additional timers. In block 1219, the UE 1600 transmits the CEF report and the CEF report list to the network node 1700.

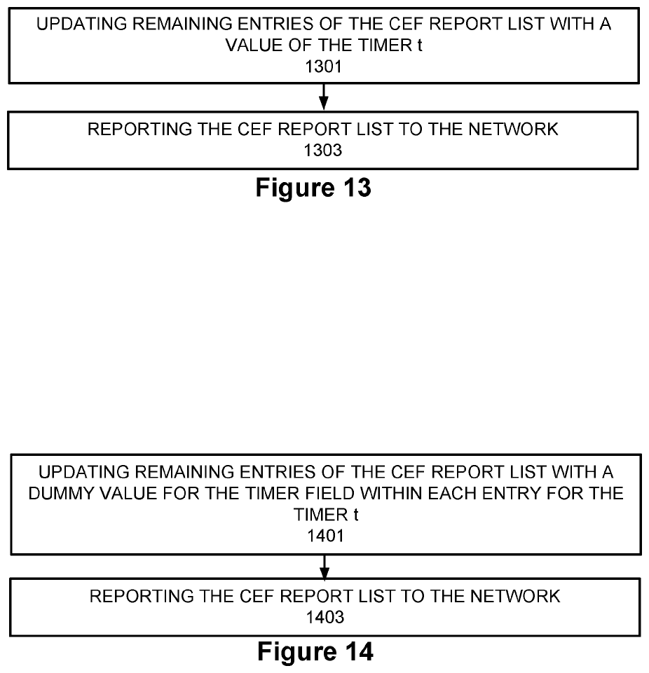

Turning to FIG. 13, in some of the other various embodiments, the UE 1600 updates remaining elements in the CEF report list with a value of timer ti in block 1301. In block 1303, the UE 1600 reports the CEF report list to the network.

In some other embodiments of the other various embodiments, the UE 1600 updates remaining elements in the CEF report list with a dummy value for the time field within each entry for the timer t as illustrated in block 1401 of FIG. 14. In some embodiments, the dummy value is zero. In block 1403, the UE 1600 reports the CEF report list to the network.

Example implementation of the embodiments described in FIGS. 1, 2A, 2B and 4-8. Possible changes are captured in the below text with double underlines.

5.3.13.5 T319 Expiry or Integrity Check Failure from Lower Layers while T319 is Running

The UE shall:
1> if timer T319 expires:
   2> if the UE has connection establishment failure information or connection resume failure information available in VarConnEstFailReport and if the RPLMN is not equal to plmn-identity stored in VarConnEstFailReport; or
   2> if the cell identity of current cell is not equal to the cell identity stored in measResultFailedCell in VarConnEstFailReport:
      3> reset the numberOfConnFail to 0;
   2> if the UE has connection establishment failure information or connection resume failure information available in VarConnEstFailReportList and if the RPLMN is not equal to plmn-identity stored in VarConnEstFailReportList:
      3> clear the content included in VarConnEstFailReportList;
   2> clear the content included in VarConnEstFailReport except for the numberOfConnFail, if any;
   2> store the following connection resume failure information in the VarConnEstFailReport by setting its fields as follows:
      3> set the plmn-Identity to the PLMN selected by upper layers (see TS 24.501 [23]) from the PLMN(s) included in the plmn-IdentityInfoList in SIBI;
      3> set the measResultFailedCell to include the global cell identity, tracking area code, the cell level and SS/PBCH block level RSRP, and RSRQ, and SS/PBCH block indexes, of the failed cell based on the available SSB measurements collected up to the moment the UE detected connection resume failure;
      3> if available, set the measResultNeighCells, in order of decreasing ranking-criterion as used for cell re-selection, to include neighbouring cell measurements for at most the following number of neighbouring cells: 6 intra-frequency and 3 inter-frequency neighbours per frequency as well as 3 inter-RAT neighbours, per frequency/set of frequencies per RAT and according to the following:
      4> for each neighbour cell included, include the optional fields that are available;
NOTE: The UE includes the latest results of the available measurements as used for cell reselection evaluation, which are performed in accordance with the performance requirements as specified in TS 38.133 [14].
   3> if available, set the locationInfo as in 5.3.3.7;
   3> set perRAInfoList to indicate the performed random access procedure related information as specified in 5.7.10.5;
   3> if numberOfConnFail is smaller than 8:
      4> increment the numberOfConnFail by 1;
   2> if the UE supports multiple CEF report:
      3> if the cgi-Info in the measResultFailedCell in the newly added VarConnEstFailReport is the same as the cgi-Info in the measResultFailedCell in the last entry in the VarConnEstFailReportList:
         4> except for the numberOfConnFail, replace all information elements for the entry with the VarConnEstFailReport:
      3> else:
         4> if the maxCEFReport-r17 has not been reached:
         5> set time Since Failure in connEstFailReport of the last entry of the VarConnEstFailReportList to the time elapsed since the connection establishment failure or connection resume failure in NR associated to last entry of the VarConnEstFailReportList.
         5> append the VarConnEstFailReport as a new entry in the VarConnEstFailReportList;
   2> perform the actions upon going to RRC_IDLE as specified in 5.3.11 with release cause ‘RRC Resume failure’.
1> else if upon receiving Integrity check failure indication from lower layers while T319 is running:
   2> perform the actions upon going to RRC_IDLE as specified in 5.3.11 with release cause ‘RRC Resume failure’.
      The UE may discard the connection resume failure or connection establishment failure information, i.e., release the UE variable VarConnEstFailReport, 48 hours after the last connection resume failure is detected.

### 5.7.10.3 Reception of the UEInformationRequest Message

Upon receiving the UEInformationRequest message, the UE shall, only after successful security activation:
1> if the idleModeMeasurementReq is included in the UEInformationRequest and the UE has stored VarMeasIdle Report that contains measurement information concerning cells other than the PCell:
   2> set the measResultIdleEUTRA in the UEInformationResponse message to the value of measReportIdleEUTRA in the VarMeasIdleReport, if available;
   2> set the measResultIdleNR in the UEInformationResponse message to the value of measReportIdleNR in the VarMeasIdleReport, if available;
   2> discard the VarMeasIdleReport upon successful delivery of the UEInformationResponse message confirmed by lower layers;
1> if the logMeasReportReq is present and if the RPLMN is included in plmn-IdentityList stored in VarLogMeasReport:
   2> if VarLogMeasReport includes one or more logged measurement entries, set the contents of the logMeasReport in the UEInformationResponse message as follows:
      3> include the absoluteTimeStamp and set it to the value of absoluteTimeInfo in the VarLogMeasReport;
      3> include the traceReference and set it to the value of traceReference in the VarLogMeasReport;
      3> include the traceRecordingSessionRef and set it to the value of traceRecordingSessionRef in the VarLogMeasReport;
      3> include the tce-Id and set it to the value of tce-Id in the VarLogMeasReport;
      3> include the logMeasInfoList and set it to include one or more entries from the VarLogMeasReport starting from the entries logged first, and for each entry of the logMeasInfoList that is included, include all information stored in the corresponding logMeasInfoList entry in VarLogMeasReport;
      3> if the VarLogMeasReport includes one or more additional logged measurement entries that are not included in the logMeasInfoList within the UEInformationResponse message:
         4> include the logMeasAvailable;
         4> if bt-LocationInfo is included in locationInfo of one or more of the additional logged measurement entries in VarLogMeasReport that are not included in the logMeasInfoList within the UEInformationResponse message:
         5> include the logMeasAvailableBT;
         4> if wlan-LocationInfo is included in locationInfo of one or more of the additional logged measurement entries in VarLogMeasReport that are not included in the logMeasInfoList within the UEInformationResponse message:
         5> include the logMeasAvailableWLAN;
1> if ra-ReportReq is set to true and the UE has random access related information available in VarRA-Report and if the RPLMN is included in plmn-IdentityList stored in VarRA-Report:
   2> set the ra-ReportList in the UEInformationResponse message to the value of ra-ReportList in VarRA-Report;
   2> discard the ra-ReportList from VarRA-Report upon successful delivery of the UEInformationResponse message confirmed by lower layers;
1> if rlf-ReportReq is set to true:
   2> if the UE has radio link failure information or handover failure information available in VarRLF-Report and if the RPLMN is included in plmn-IdentityList stored in VarRLF-Report:
      3> set timeSinceFailure in VarRLF-Report to the time that elapsed since the last radio link failure or handover failure in NR;
      3> set the rlf-Report in the UEInformationResponse message to the value of rlf-Report in VarRLF-Report;
      3> discard the rlf-Report from VarRLF-Report upon successful delivery of the UEInformationResponse message confirmed by lower layers;
   2> else if the UE is capable of cross-RAT RLF reporting as defined in TS 38.306 and has radio link failure information or handover failure information available in VarRLF-Report of TS 36.331 and if the RPLMN is included in plmn-IdentityList stored in VarRLF-Report of TS 36.331 [10]:
      3> set timeSinceFailure in VarRLF-Report of TS 36.331 to the time that elapsed since the last radio link failure or handover failure in EUTRA;
      3> set failedPCellId-EUTRA in the rlf-Report in the UEInformationResponse message to indicate the PCell in which RLF was detected or the source PCell of the failed handover in the VarRLF-Report of TS 36.331 [10];
      3> set the measResult-RLF-Report-EUTRA in the rlf-Report in the UEInformationResponse message to the value of rlf-Report in VarRLF-Report of TS 36.331 [10];
      3> discard the rlf-Report from VarRLF-Report of TS 36.331 upon successful delivery of the UEInformationResponse message confirmed by lower layers;
1> if connEstFailReportReq is set to true and the UE has connection establishment failure or connection resume failure information in VarConnEstFailReport or VarConnEstFailReportList and if the RPLMN is equal to plmn-Identity stored in VarConnEstFailReport:
   2> set timeSinceFailure in VarConnEstFailReport and timeSinceFailure for the last entry in the connEstFailReportList to the time that elapsed since the last connection establishment failure or connection resume failure in NR;
   2> set the connEstFailReport in the UEInformationResponse message to the value of connEstFailReport in VarConnEstFailReport;
   2> for each connEstFailReport in the connEstFailReportList in the UEInformationResponse message, set the value to the value of connEstFailReport in VarConnEstFailReport in VarConnEstFailReportList;
   2> discard the connEstFailReport from VarConnEstFailReport and VarConnEstFailReportList upon successful delivery of the UEInformationResponse message confirmed by lower layers;

Example implantation of the embodiments described in FIGS. 3 and 9-11. Possible changes are captured in the below text with double underlines.

### 5.7.10.3 Reception of the UEInformationRequest Message

Upon receiving the UEInformationRequest message, the UE shall, only after successful security activation:
1> if the idleModeMeasurementReq is included in the UEInformationRequest and the UE has stored VarMeasIdle Report that contains measurement information concerning cells other than the PCell:
   2> set the measResultIdleEUTRA in the UEInformationResponse message to the value of measReportIdleEUTRA in the VarMeasIdleReport, if available;
   2> set the measResultIdleNR in the UEInformationResponse message to the value of measReportIdleNR in the VarMeasIdleReport, if available;
   2> discard the VarMeasIdleReport upon successful delivery of the UEInformationResponse message confirmed by lower layers;
1> if the logMeasReportReq is present and if the RPLMN is included in plmn-IdentityList stored in VarLogMeasReport:
   2> if VarLogMeasReport includes one or more logged measurement entries, set the contents of the logMeasReport in the UEInformationResponse message as follows:
      3> include the absoluteTimeStamp and set it to the value of absoluteTimeInfo in the VarLogMeasReport;
      3> include the traceReference and set it to the value of traceReference in the VarLogMeasReport;
      3> include the traceRecordingSessionRef and set it to the value of traceRecordingSessionRef in the VarLogMeasReport;
      3> include the tce-Id and set it to the value of tce-Id in the VarLogMeasReport;
      3> include the logMeasInfoList and set it to include one or more entries from the VarLogMeasReport starting from the entries logged first, and for each entry of the logMeasInfoList that is included, include all information stored in the corresponding logMeasInfoList entry in VarLogMeasReport;
      3> if the VarLogMeasReport includes one or more additional logged measurement entries that are not included in the logMeasInfoList within the UEInformationResponse message:
         4> include the logMeasAvailable;
         4> if bt-LocationInfo is included in locationInfo of one or more of the additional logged measurement entries in VarLogMeasReport that are not included in the logMeasInfoList within the UEInformationResponse message:
         5> include the logMeasAvailable BT;
         4> if wlan-LocationInfo is included in locationInfo of one or more of the additional logged measurement entries in VarLogMeasReport that are not included in the logMeasInfoList within the UEInformationResponse message:
         5> include the logMeasAvailableWLAN;
1> if ra-ReportReq is set to true and the UE has random access related information available in VarRA-Report and if the RPLMN is included in plmn-IdentityList stored in VarRA-Report:
   2> set the ra-ReportList in the UEInformationResponse message to the value of ra-ReportList in VarRA-Report;
   2> discard the ra-ReportList from VarRA-Report upon successful delivery of the UEInformationResponse message confirmed by lower layers;
1> if rlf-ReportReq is set to true:
   2> if the UE has radio link failure information or handover failure information available in VarRLF-Report and if the RPLMN is included in plmn-IdentityList stored in VarRLF-Report:
      3> set timeSinceFailure in VarRLF-Report to the time that elapsed since the last radio link failure or handover failure in NR;
      3> set the rlf-Report in the UEInformationResponse message to the value of rlf-Report in VarRLF-Report;
      3> discard the rlf-Report from VarRLF-Report upon successful delivery of the UEInformationResponse message confirmed by lower layers;
   2> else if the UE is capable of cross-RAT RLF reporting as defined in TS 38.306 and has radio link failure information or handover failure information available in VarRLF-Report of TS 36.331 and if the RPLMN is included in plmn-IdentityList stored in VarRLF-Report of TS 36.331 [10]:
      3> set timeSinceFailure in VarRLF-Report of TS 36.331 to the time that elapsed since the last radio link failure or handover failure in EUTRA;
      3> set failedPCellId-EUTRA in the rlf-Report in the UEInformationResponse message to indicate the PCell in which RLF was detected or the source PCell of the failed handover in the VarRLF-Report of TS 36.331 [10];
      3> set the measResult-RLF-Report-EUTRA in the rlf-Report in the UEInformationResponse message to the value of rlf-Report in VarRLF-Report of TS 36.331 [10];
      3> discard the rlf-Report from VarRLF-Report of TS 36.331 upon successful delivery of the UEInformationResponse message confirmed by lower layers;
1> if connEstFailReportReq is set to true and the UE has connection establishment failure or connection resume failure information in VarConnEstFailReport or VarConnEstFailReportList and if the RPLMN is equal to plmn-Identity stored in VarConnEstFailReport:
   2> set timeSinceFailure in VarConnEstFailReport to the time that elapsed since the last connection establishment failure or connection resume failure in NR;
   2> set the connEstFailReport in the UEInformationResponse message to the value of connEstFailReport in VarConnEstFailReport;
   2> for each connEstFailReport in the connEstFailReportList in VarConnEstFailReportList:
      3> set timeSinceFailure to the time that elapsed since the associated connection establishment failure or connection resume failure in NR;
   2> for each connEstFailReport in the connEstFailReportList in the UEInformationResponse message, set the value to the value of connEstFailReport in VarConnEstFailReport in VarConnEstFailReportList;
   2> discard the connEstFailReport from VarConnEstFailReport and VarConnEstFailReportList upon successful delivery of the UEInformationResponse message confirmed by lower layers;
1> if the mobilityHistoryReportReq is set to true:
   2> include the mobilityHistoryReport and set it to include visitedCellInfoList from VarMobilityHistoryReport;
   2> include in the mobilityHistoryReport an entry for the current PCell, possibly after removing the oldest entry if required, and set its fields as follows:
      3> set visitedCellId to the global cell identity or the physical cell identity and carrier frequency of the current PCell:
      3> set field timeSpent to the time spent in the current PCell;
      3> if visitedPSCellInfoList is present in VarMobilityHistoryReport:
         4> for the newest entry of the PCell in the mobiliyHistoryReport, include visitedPSCellInfoList from VarMobilityHistoryReport;
         4> if the UE is configured with a PSCell:
         5> for the newest entry of the PCell in the mobiliyHistoryReport, include the current PSCell information in the visitedPSCellInfoList, possibly after removing the oldest entry, if required, and set its fields as follows:
         6> set visitedCellld to the global cell identity or the physical cell identity and carrier frequency of the current PSCell:
         6> set field timeSpent to the time spent in the current PSCell while being connected to the current PCell;
         4> else:
         5> for the newest entry of the PCell in the mobiliyHistoryReport, include a new entry in the visitedPSCellInfoList, possibly after removing the oldest entry, if required, and set its fields as follows:
         6> set field timeSpent to the time spent without PSCell in the current PCell since last PSCell release or secondary cell radio link failure since connected to the current PCell in RRC_CONNECTED;
      3> else:
         4> if the UE is configured with a PSCell:
         5> for the newest entry of the PCell in the mobiliyHistoryReport, include the current PSCell information in the visitedPSCellInfoList, possibly after removing the oldest entry, if required, and set its fields as follows:
         6> set visitedCellld to the global cell identity or the physical cell identity and carrier frequency of the current PSCell:
         ·6> set field timeSpent to the time spent in the current PSCell while being connected to the current PCell;
         4> else:
         5> for the newest entry of the PCell in the mobiliyHistoryReport, include a new entry in the visitedPSCellInfoList, possibly after removing the oldest entry, if required, and set its fields as follows:
         6> set field timeSpent to the time spent without PSCell in the current PCell since connected to the current PCell in RRC_CONNECTED;
1> if the successHO-ReportReq is set to true and if the RPLMN is included in the plmn-IdentityList stored in VarSuccessHO-Report:
   2> if the successHO-Report in the VarSuccessHO-Report concerns a DAPS handover:
      3> set upInterruptionTimeAtHO in VarSuccessHO-Report to include the time elapsed between the time of arrival of the last PDCP PDU received from the source cell of the concerned handover and the time of arrival of the first non-duplicate PDCP PDU received from the target cell of the concerned handover, as measured at the time of arrival of the first non-duplicate PDCP PDU received from the target cell
   2> set the successHO-Report in the UEInformationResponse message to the value of successHO-Report in the VarSuccessHO-Report, if available;
   2> discard the VarSuccessHO-Report upon successful delivery of the UEInformationResponse message confirmed by lower layers;
1> if the logMeasReport is included in the UEInformationResponse:
   2> submit the UEInformationResponse message to lower layers for transmission via SRB2;
   2> discard the logged measurement entries included in the logMeasInfoList from VarLogMeasReport upon successful delivery of the UEInformationResponse message confirmed by lower layers;
1> else:
   2> submit the UEInformationResponse message to lower layers for transmission via SRB1.

Example implantation of the embodiments described in FIGS. 12-14. Possible changes are captured in the below text with double underlines.

### 5.7.10.3 Reception of the UEInformationRequest Message

Upon receiving the UEInformationRequest message, the UE shall, only after successful security activation:
1> if the idleModeMeasurementReq is included in the UEInformationRequest and the UE has stored VarMeasIdleReport that contains measurement information concerning cells other than the PCell:
   2> set the measResultIdleEUTRA in the UEInformationResponse message to the value of measReportIdleEUTRA in the VarMeasIdleReport, if available;
   2> set the measResultIdleNR in the UEInformationResponse message to the value of measReportIdleNR in the VarMeasIdleReport, if available;
   2> discard the VarMeasIdleReport upon successful delivery of the UEInformationResponse message confirmed by lower layers;
1> if the logMeasReportReq is present and if the RPLMN is included in plmn-IdentityList stored in VarLogMeasReport:
   2> if VarLogMeasReport includes one or more logged measurement entries, set the contents of the logMeasReport in the UEInformationResponse message as follows:
      3> include the absoluteTimeStamp and set it to the value of absoluteTimeInfo in the VarLogMeasReport;
      3> include the traceReference and set it to the value of traceReference in the VarLogMeasReport;
      3> include the traceRecordingSessionRef and set it to the value of trace RecordingSessionRef in the VarLogMeasReport;
      3> include the tce-Id and set it to the value of tce-Id in the VarLogMeasReport;
      3> include the logMeasInfoList and set it to include one or more entries from the VarLogMeasReport starting from the entries logged first, and for each entry of the logMeasInfoList that is included, include all information stored in the corresponding logMeasInfoList entry in VarLogMeasReport;
      3> if the VarLogMeasReport includes one or more additional logged measurement entries that are not included in the logMeasInfoList within the UEInformationResponse message:
         4> include the logMeasAvailable;
         4> if bt-LocationInfo is included in locationInfo of one or more of the additional logged measurement entries in VarLogMeasReport that are not included in the logMeasInfoList within the UEInformationResponse message:
         5> include the logMeasAvailableBT;
         4> if wlan-LocationInfo is included in locationInfo of one or more of the additional logged measurement entries in VarLogMeasReport that are not included in the logMeasInfoList within the UEInformationResponse message:
         5> include the logMeasAvailableWLAN;
1> if ra-ReportReq is set to true and the UE has random access related information available in VarRA-Report and if the RPLMN is included in plmn-IdentityList stored in VarRA-Report:
   2> set the ra-ReportList in the UEInformationResponse message to the value of ra-ReportList in VarRA-Report;
   2> discard the ra-ReportList from VarRA-Report upon successful delivery of the UEInformationResponse message confirmed by lower layers;
1> if rlf-ReportReq is set to true:
   2> if the UE has radio link failure information or handover failure information available in VarRLF-Report and if the RPLMN is included in plmn-IdentityList stored in VarRLF-Report:
      3> set timeSinceFailure in VarRLF-Report to the time that elapsed since the last radio link failure or handover failure in NR;
      3> set the rlf-Report in the UEInformationResponse message to the value of rlf-Report in VarRLF-Report;
      3> discard the rlf-Report from VarRLF-Report upon successful delivery of the UEInformationResponse message confirmed by lower layers;
   2> else if the UE is capable of cross-RAT RLF reporting as defined in TS 38.306 and has radio link failure information or handover failure information available in VarRLF-Report of TS 36.331 and if the RPLMN is included in plmn-IdentityList stored in VarRLF-Report of TS 36.331 [10]:
      3> set timeSinceFailure in VarRLF-Report of TS 36.331 to the time that elapsed since the last radio link failure or handover failure in EUTRA;
      3> set failedPCellId-EUTRA in the rlf-Report in the UEInformationResponse message to indicate the PCell in which RLF was detected or the source PCell of the failed handover in the VarRLF-Report of TS 36.331 [10];
      3> set the measResult-RLF-Report-EUTRA in the rlf-Report in the UEInformationResponse message to the value of rlf-Report in VarRLF-Report of TS 36.331 [10];
      3> discard the rlf-Report from VarRLF-Report of TS 36.331 upon successful delivery of the UEInformationResponse message confirmed by lower layers;
1> if connEstFailReportReq is set to true and the UE has connection establishment failure or connection resume failure information in VarConnEstFailReport or VarConnEstFailReportList and if the RPLMN is equal to plmn-Identity stored in VarConnEstFailReport:
   2> set timeSinceFailure in VarConnEstFailReport to the time that elapsed since the last connection establishment failure or connection resume failure in NR;
   2> set the connEstFailReport in the UEInformationResponse message to the value of connEstFailReport in VarConnEstFailReport;
   2> for each connEstFailReport in the connEstFailReportList in the UEInformationResponse message, set the value to the value of connEstFailReport in VarConnEstFailReport in VarConnEstFailReportList;
   2> set timeSinceFailure in VarConnEstFailReportList as follows;
      3> for the last element in connEstFailReport, set timeSinceFailure to the time that elapsed since the last connection establishment failure or connection resume failure in NR:
      3> for other elements in connEstFailReport. set time SinceFailure to zero or any dummy value.
   2> discard the connEstFailReport from VarConnEstFailReport and VarConnEstFailReportList upon successful delivery of the UEInformationResponse message confirmed by lower layers;
1> if the mobilityHistoryReportReq is set to true:
   2> include the mobilityHistoryReport and set it to include entries from VarMobilityHistoryReport;
   2> include in the mobilityHistoryReport an entry for the current cell, possibly after removing the oldest entry if required, and set its fields as follows:
      3> set visitedCellId to the global cell identity or the physical cell identity and carrier frequency of the current cell:
      3> set field timeSpent to the time spent in the current cell;
1> if the logMeasReport is included in the UEInformationResponse:
   2> submit the UEInformationResponse message to lower layers for transmission via SRB2;
   2> discard the logged measurement entries included in the logMeasInfoList from VarLogMeasReport upon successful delivery of the UEInformationResponse message confirmed by lower layers;
1> else:
   2> submit the UEInformationResponse message to lower layers for transmission via SRB1.

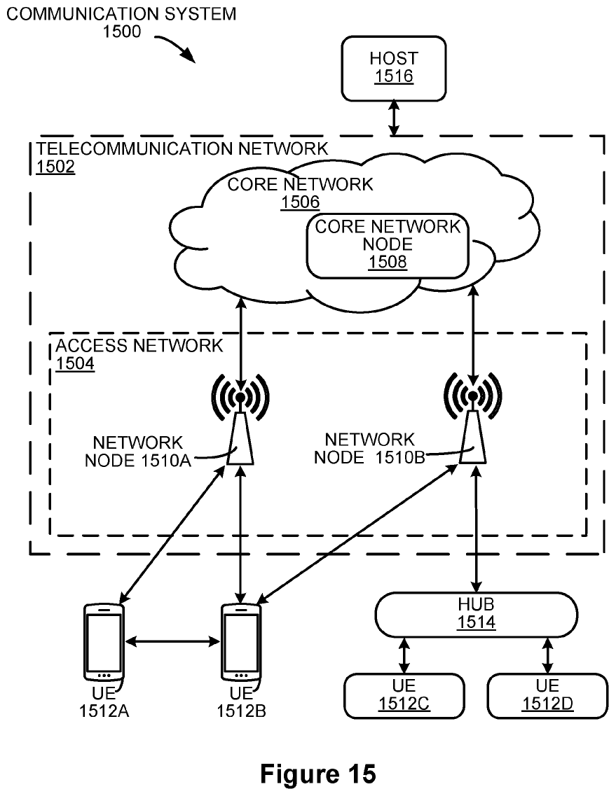

FIG. 15 shows an example of a communication system 1500 in accordance with some embodiments.

In the example, the communication system 1500 includes a telecommunication network 1502 that includes an access network 1504, such as a radio access network (RAN), and a core network 1506, which includes one or more core network nodes 1508. The access network 1504 includes one or more access network nodes, such as network nodes 1510A and 1510B (one or more of which may be generally referred to as network nodes 1510), or any other similar 3rd Generation Partnership Project (3GPP) access node or non−3GPP access point. The network nodes 1510 facilitate direct or indirect connection of user equipment (UE), such as by connecting UEs 1512A, 1512B, 1512C, and 1512D (one or more of which may be generally referred to as UEs 1512) to the core network 1506 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1500 may include any number of wired or wireless networks, network nodes, UEs, and/or any other components or systems that may facilitate or participate in the communication of data and/or signals whether via wired or wireless connections. The communication system 1500 may include and/or interface with any type of communication, telecommunication, data, cellular, radio network, and/or other similar type of system.

The UEs 1512 may be any of a wide variety of communication devices, including wireless devices arranged, configured, and/or operable to communicate wirelessly with the network nodes 1510 and other communication devices. Similarly, the network nodes 1510 are arranged, capable, configured, and/or operable to communicate directly or indirectly with the UEs 1512 and/or with other network nodes or equipment in the telecommunication network 1502 to enable and/or provide network access, such as wireless network access, and/or to perform other functions, such as administration in the telecommunication network 1502.

In the depicted example, the core network 1506 connects the network nodes 1510 to one or more hosts, such as host 1516. These connections may be direct or indirect via one or more intermediary networks or devices. In other examples, network nodes may be directly coupled to hosts. The core network 1506 includes one more core network nodes (e.g., core network node 1508) that are structured with hardware and software components. Features of these components may be substantially similar to those described with respect to the UEs, network nodes, and/or hosts, such that the descriptions thereof are generally applicable to the corresponding components of the core network node 1508. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1516 may be under the ownership or control of a service provider other than an operator or provider of the access network 1504 and/or the telecommunication network 1502, and may be operated by the service provider or on behalf of the service provider. The host 1516 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1500 of FIG. 15 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1502 is a cellular network that implements 3GPP standardized features. Accordingly, the telecommunications network 1502 may support network slicing to provide different logical networks to different devices that are connected to the telecommunication network 1502. For example, the telecommunications network 1502 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs. In some examples, the UEs 1512 are configured to transmit and/or receive

information without direct human interaction. For instance, a UE may be designed to transmit information to the access network 1504 on a predetermined schedule, when triggered by an internal or external event, or in response to requests from the access network 1504. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 1514 communicates with the access network 1504 to facilitate indirect communication between one or more UEs (e.g., UE 1512C and/or 1512D) and network nodes (e.g., network node 1510B). In some examples, the hub 1514 may be a controller, router, content source and analytics, or any of the other communication devices described herein regarding UEs. For example, the hub 1514 may be a broadband router enabling access to the core network 1506 for the UEs. As another example, the hub 1514 may be a controller that sends commands or instructions to one or more actuators in the UEs. Commands or instructions may be received from the UEs, network nodes 1510, or by executable code, script, process, or other instructions in the hub 1514. As another example, the hub 1514 may be a data collector that acts as temporary storage for UE data and, in some embodiments, may perform analysis or other processing of the data. As another example, the hub 1514 may be a content source. For example, for a UE that is a VR headset, display, loudspeaker or other media delivery device, the hub 1514 may retrieve VR assets, video, audio, or other media or data related to sensory information via a network node, which the hub 1514 then provides to the UE either directly, after performing local processing, and/or after adding additional local content. In still another example, the hub 1514 acts as a proxy server or orchestrator for the UEs, in particular in if one or more of the UEs are low energy IoT devices.

The hub 1514 may have a constant/persistent or intermittent connection to the network node 1510B. The hub 1514 may also allow for a different communication scheme and/or schedule between the hub 1514 and UEs (e.g., UE 1512C and/or 1512D), and between the hub 1514 and the core network 1506. In other examples, the hub 1514 is connected to the core network 1506 and/or one or more UEs via a wired connection. Moreover, the hub 1514 may be configured to connect to an M2M service provider over the access network 1504 and/or to another UE over a direct connection. In some scenarios, UEs may establish a wireless connection with the network nodes 1510 while still connected via the hub 1514 via a wired or wireless connection. In some embodiments, the hub 1514 may be a dedicated hub—that is, a hub whose primary function is to route communications to/from the UEs from/to the network node 1510B. In other embodiments, the hub 1514 may be a non-dedicated hub—that is, a device which is capable of operating to route communications between the UEs and network node 1510B, but which is additionally capable of operating as a communication start and/or end point for certain data channels.

FIG. 16 shows a UE 1600 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1600 includes processing circuitry 1602 that is operatively coupled via a bus 1604 to an input/output interface 1606, a power source 1608, a memory 1610, a communication interface 1612, and/or any other component, or any combination thereof. Certain UEs may utilize all or a subset of the components shown in FIG. 16. The level of integration between the components may vary from one UE to another UE. Further, certain UEs may contain multiple instances of a component, such as multiple processors, memories, transceivers, transmitters, receivers, etc.

The processing circuitry 1602 is configured to process instructions and data and may be configured to implement any sequential state machine operative to execute instructions stored as machine-readable computer programs in the memory 1610. The processing circuitry 1602 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1602 may include multiple central processing units (CPUs).

In the example, the input/output interface 1606 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1600. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1608 is structured as a battery or battery pack. Other types of power sources, such as an external power source (e.g., an electricity outlet), photovoltaic device, or power cell, may be used. The power source 1608 may further include power circuitry for delivering power from the power source 1608 itself, and/or an external power source, to the various parts of the UE 1600 via input circuitry or an interface such as an electrical power cable. Delivering power may be, for example, for charging of the power source 1608. Power circuitry may perform any formatting, converting, or other modification to the power from the power source 1608 to make the power suitable for the respective components of the UE 1600 to which power is supplied.

The memory 1610 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1610 includes one or more application programs 1614, such as an operating system, web browser application, a widget, gadget engine, or other application, and corresponding data 1616. The memory 1610 may store, for use by the UE 1600, any of a variety of various operating systems or combinations of operating systems.

The memory 1610 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1610 may allow the UE 1600 to access instructions, application programs and the like, stored on transitory or non-transitory memory media, to off-load data, or to upload data. An article of manufacture, such as one utilizing a communication system may be tangibly embodied as or in the memory 1610, which may be or comprise a device-readable storage medium.

The processing circuitry 1602 may be configured to communicate with an access network or other network using the communication interface 1612. The communication interface 1612 may comprise one or more communication subsystems and may include or be communicatively coupled to an antenna 1622. The communication interface 1612 may include one or more transceivers used to communicate, such as by communicating with one or more remote transceivers of another device capable of wireless communication (e.g., another UE or a network node in an access network). Each transceiver may include a transmitter 1618 and/or a receiver 1620 appropriate to provide network communications (e.g., optical, electrical, frequency allocations, and so forth). Moreover, the transmitter 1618 and receiver 1620 may be coupled to one or more antennas (e.g., antenna 1622) and may share circuit components, software or firmware, or alternatively be implemented separately.

In the illustrated embodiment, communication functions of the communication interface 1612 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1612, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1600 shown in FIG. 16.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 17 shows a network node 1700 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1700 includes a processing circuitry 1702, a memory 1704, a communication interface 1706, and a power source 1708. The network node 1700 may be composed of multiple physically separate components (e.g., a NodeB component and a RNC component, or a BTS component and a BSC component, etc.), which may each have their own respective components. In certain scenarios in which the network node 1700 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1700 may be configured to support multiple radio access technologies (RATs). In such embodiments, some components may be duplicated (e.g., separate memory 1704 for different RATs) and some components may be reused (e.g., a same antenna 1710 may be shared by different RATs). The network node 1700 may also include multiple sets of the various illustrated components for different wireless technologies integrated into network node 1700, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1700.

The processing circuitry 1702 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1700 components, such as the memory 1704, to provide network node 1700 functionality.

In some embodiments, the processing circuitry 1702 includes a system on a chip (SOC). In some embodiments, the processing circuitry 1702 includes one or more of radio frequency (RF) transceiver circuitry 1712 and baseband processing circuitry 1714. In some embodiments, the radio frequency (RF) transceiver circuitry 1712 and the baseband processing circuitry 1714 may be on separate chips (or sets of chips), boards, or units, such as radio units and digital units. In alternative embodiments, part or all of RF transceiver circuitry 1712 and baseband processing circuitry 1714 may be on the same chip or set of chips, boards, or units.

The memory 1704 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1702. The memory 1704 may store any suitable instructions, data, or information, including a computer program, software, an application including one or more of logic, rules, code, tables, and/or other instructions capable of being executed by the processing circuitry 1702 and utilized by the network node 1700. The memory 1704 may be used to store any calculations made by the processing circuitry 1702 and/or any data received via the communication interface 1706. In some embodiments, the processing circuitry 1702 and memory 1704 is integrated.

The communication interface 1706 is used in wired or wireless communication of signaling and/or data between a network node, access network, and/or UE. As illustrated, the communication interface 1706 comprises port(s)/terminal(s) 1716 to send and receive data, for example to and from a network over a wired connection. The communication interface 1706 also includes radio front-end circuitry 1718 that may be coupled to, or in certain embodiments a part of, the antenna 1710. Radio front-end circuitry 1718 comprises filters 1720 and amplifiers 1722. The radio front-end circuitry 1718 may be connected to an antenna 1710 and processing circuitry 1702. The radio front-end circuitry may be configured to condition signals communicated between antenna 1710 and processing circuitry 1702. The radio front-end circuitry 1718 may receive digital data that is to be sent out to other network nodes or UEs via a wireless connection. The radio front-end circuitry 1718 may convert the digital data into a radio signal having the appropriate channel and bandwidth parameters using a combination of filters 1720 and/or amplifiers 1722. The radio signal may then be transmitted via the antenna 1710. Similarly, when receiving data, the antenna 1710 may collect radio signals which are then converted into digital data by the radio front-end circuitry 1718. The digital data may be passed to the processing circuitry 1702. In other embodiments, the communication interface may comprise different components and/or different combinations of components.

In certain alternative embodiments, the network node 1700 does not include separate radio front-end circuitry 1718, instead, the processing circuitry 1702 includes radio front-end circuitry and is connected to the antenna 1710. Similarly, in some embodiments, all or some of the RF transceiver circuitry 1712 is part of the communication interface 1706. In still other embodiments, the communication interface 1706 includes one or more ports or terminals 1716, the radio front-end circuitry 1718, and the RF transceiver circuitry 1712, as part of a radio unit (not shown), and the communication interface 1706 communicates with the baseband processing circuitry 1714, which is part of a digital unit (not shown).

The antenna 1710 may include one or more antennas, or antenna arrays, configured to send and/or receive wireless signals. The antenna 1710 may be coupled to the radio front-end circuitry 1718 and may be any type of antenna capable of transmitting and receiving data and/or signals wirelessly. In certain embodiments, the antenna 1710 is separate from the network node 1700 and connectable to the network node 1700 through an interface or port.

The antenna 1710, communication interface 1706, and/or the processing circuitry 1702 may be configured to perform any receiving operations and/or certain obtaining operations described herein as being performed by the network node. Any information, data and/or signals may be received from a UE, another network node and/or any other network equipment. Similarly, the antenna 1710, the communication interface 1706, and/or the processing circuitry 1702 may be configured to perform any transmitting operations described herein as being performed by the network node. Any information, data and/or signals may be transmitted to a UE, another network node and/or any other network equipment.

The power source 1708 provides power to the various components of network node 1700 in a form suitable for the respective components (e.g., at a voltage and current level needed for each respective component). The power source 1708 may further comprise, or be coupled to, power management circuitry to supply the components of the network node 1700 with power for performing the functionality described herein. For example, the network node 1700 may be connectable to an external power source (e.g., the power grid, an electricity outlet) via an input circuitry or interface such as an electrical cable, whereby the external power source supplies power to power circuitry of the power source 1708. As a further example, the power source 1708 may comprise a source of power in the form of a battery or battery pack which is connected to, or integrated in, power circuitry. The battery may provide backup power should the external power source fail.

Embodiments of the network node 1700 may include additional components beyond those shown in FIG. 17 for providing certain aspects of the network node's functionality, including any of the functionality described herein and/or any functionality necessary to support the subject matter described herein. For example, the network node 1700 may include user interface equipment to allow input of information into the network node 1700 and to allow output of information from the network node 1700. This may allow a user to perform diagnostic, maintenance, repair, and other administrative functions for the network node 1700.

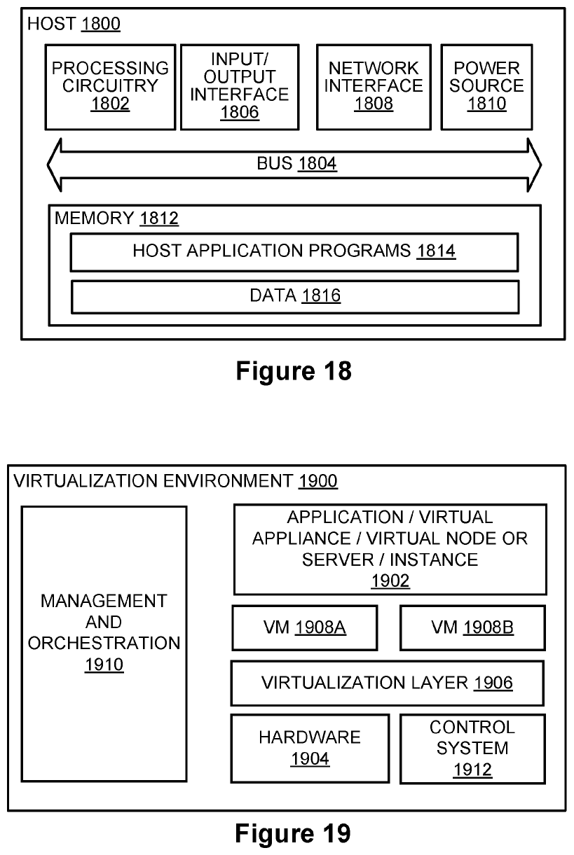

FIG. 18 is a block diagram of a host 1800, which may be an embodiment of the host 1516 of FIG. 15, in accordance with various aspects described herein. As used herein, the host 1800 may be or comprise various combinations hardware and/or software, including a standalone server, a blade server, a cloud-implemented server, a distributed server, a virtual machine, container, or processing resources in a server farm. The host 1800 may provide one or more services to one or more UEs.

The host 1800 includes processing circuitry 1802 that is operatively coupled via a bus 1804 to an input/output interface 1806, a network interface 1808, a power source 1810, and a memory 1812. Other components may be included in other embodiments. Features of these components may be substantially similar to those described with respect to the devices of previous figures, such as FIGS. 16 and 17, such that the descriptions thereof are generally applicable to the corresponding components of host 1800.

The memory 1812 may include one or more computer programs including one or more host application programs 1814 and data 1816, which may include user data, e.g., data generated by a UE for the host 1800 or data generated by the host 1800 for a UE. Embodiments of the host 1800 may utilize only a subset or all of the components shown. The host application programs 1814 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1814 may also provide for user authentication and licensing checks and may periodically report health, routes, and content availability to a central node, such as a device in or on the edge of a core network. Accordingly, the host 1800 may select and/or indicate a different host for over-the-top services for a UE. The host application programs 1814 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 19 is a block diagram illustrating a virtualization environment 1900 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1900 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1902 (which may alternatively be called software instances, virtual appliances, network functions, virtual nodes, virtual network functions, etc.) are run in the virtualization environment 1900 to implement some of the features, functions, and/or benefits of some of the embodiments disclosed herein.

Hardware 1904 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1906 (also referred to as hypervisors or virtual machine monitors (VMMs)), provide VMs 1908A and 1908B (one or more of which may be generally referred to as VMs 1908), and/or perform any of the functions, features and/or benefits described in relation with some embodiments described herein. The virtualization layer 1906 may present a virtual operating platform that appears like networking hardware to the VMs 1908.

The VMs 1908 comprise virtual processing, virtual memory, virtual networking or interface and virtual storage, and may be run by a corresponding virtualization layer 1906. Different embodiments of the instance of a virtual appliance 1902 may be implemented on one or more of VMs 1908, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1908 may be a software implementation of a physical machine that runs programs as if they were executing on a physical, non-virtualized machine. Each of the VMs 1908, and that part of hardware 1904 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1908 on top of the hardware 1904 and corresponds to the application 1902.

Hardware 1904 may be implemented in a standalone network node with generic or specific components. Hardware 1904 may implement some functions via virtualization. Alternatively, hardware 1904 may be part of a larger cluster of hardware (e.g., such as in a data center or CPE) where many hardware nodes work together and are managed via management and orchestration 1910, which, among others, oversees lifecycle management of applications 1902. In some embodiments, hardware 1904 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1912 which may alternatively be used for communication between hardware nodes and radio units.

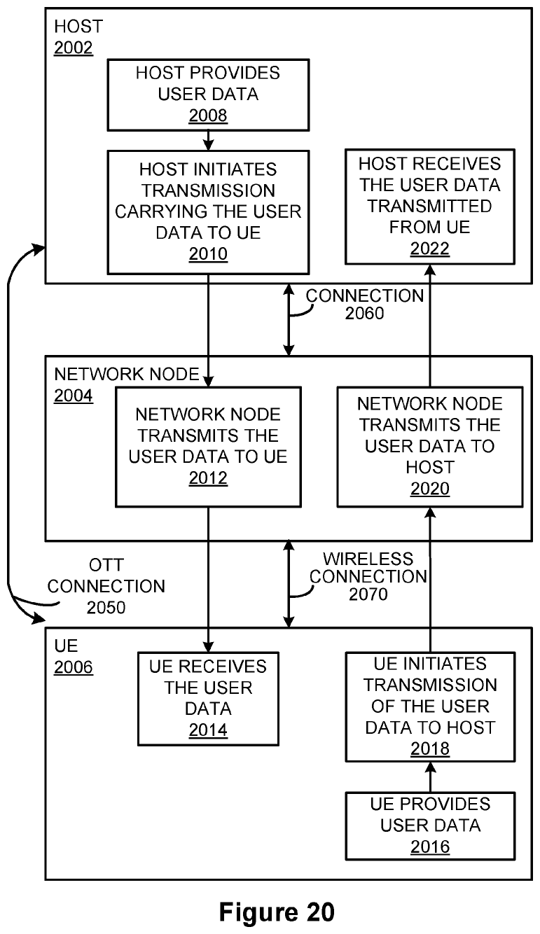

FIG. 20 shows a communication diagram of a host 2002 communicating via a network node 2004 with a UE 2006 over a partially wireless connection in accordance with some embodiments. Example implementations, in accordance with various embodiments, of the UE (such as a UE 1512A of FIG. 15 and/or UE 1600 of FIG. 16), network node (such as network node 1510A of FIG. 15 and/or network node 1700 of FIG. 17), and host (such as host 1516 of FIG. 15 and/or host 1800 of FIG. 18) discussed in the preceding paragraphs will now be described with reference to FIG. 20.

Like host 1800, embodiments of host 2002 include hardware, such as a communication interface, processing circuitry, and memory. The host 2002 also includes software, which is stored in or accessible by the host 2002 and executable by the processing circuitry. The software includes a host application that may be operable to provide a service to a remote user, such as the UE 2006 connecting via an over-the-top (OTT) connection 2050 extending between the UE 2006 and host 2002. In providing the service to the remote user, a host application may provide user data which is transmitted using the OTT connection 2050.

The network node 2004 includes hardware enabling it to communicate with the host 2002 and UE 2006. The connection 2060 may be direct or pass through a core network (like core network 1506 of FIG. 15) and/or one or more other intermediate networks, such as one or more public, private, or hosted networks. For example, an intermediate network may be a backbone network or the Internet.

The UE 2006 includes hardware and software, which is stored in or accessible by UE 2006 and executable by the UE's processing circuitry. The software includes a client application, such as a web browser or operator-specific “app” that may be operable to provide a service to a human or non-human user via UE 2006 with the support of the host 2002. In the host 2002, an executing host application may communicate with the executing client application via the OTT connection 2050 terminating at the UE 2006 and host 2002. In providing the service to the user, the UE's client application may receive request data from the host's host application and provide user data in response to the request data. The OTT connection 2050 may transfer both the request data and the user data. The UE's client application may interact with the user to generate the user data that it provides to the host application through the OTT connection 2050.

The OTT connection 2050 may extend via a connection 2060 between the host 2002 and the network node 2004 and via a wireless connection 2070 between the network node 2004 and the UE 2006 to provide the connection between the host 2002 and the UE 2006. The connection 2060 and wireless connection 2070, over which the OTT connection 2050 may be provided, have been drawn abstractly to illustrate the communication between the host 2002 and the UE 2006 via the network node 2004, without explicit reference to any intermediary devices and the precise routing of messages via these devices.

As an example of transmitting data via the OTT connection 2050, in step 2008, the host 2002 provides user data, which may be performed by executing a host application. In some embodiments, the user data is associated with a particular human user interacting with the UE 2006. In other embodiments, the user data is associated with a UE 2006 that shares data with the host 2002 without explicit human interaction. In step 2010, the host 2002 initiates a transmission carrying the user data towards the UE 2006. The host 2002 may initiate the transmission responsive to a request transmitted by the UE 2006. The request may be caused by human interaction with the UE 2006 or by operation of the client application executing on the UE 2006. The transmission may pass via the network node 2004, in accordance with the teachings of the embodiments described throughout this disclosure. Accordingly, in step 2012, the network node 2004 transmits to the UE 2006 the user data that was carried in the transmission that the host 2002 initiated, in accordance with the teachings of the embodiments described throughout this disclosure. In step 2014, the UE 2006 receives the user data carried in the transmission, which may be performed by a client application executed on the UE 2006 associated with the host application executed by the host 2002.

In some examples, the UE 2006 executes a client application which provides user data to the host 2002. The user data may be provided in reaction or response to the data received from the host 2002. Accordingly, in step 2016, the UE 2006 may provide user data, which may be performed by executing the client application. In providing the user data, the client application may further consider user input received from the user via an input/output interface of the UE 2006. Regardless of the specific manner in which the user data was provided, the UE 2006 initiates, in step 2018, transmission of the user data towards the host 2002 via the network node 2004. In step 2020, in accordance with the teachings of the embodiments described throughout this disclosure, the network node 2004 receives user data from the UE 2006 and initiates transmission of the received user data towards the host 2002. In step 2022, the host 2002 receives the user data carried in the transmission initiated by the UE 2006.

In an example scenario, factory status information may be collected and analyzed by the host 2002. As another example, the host 2002 may process audio and video data which may have been retrieved from a UE for use in creating maps. As another example, the host 2002 may collect and analyze real-time data to assist in controlling vehicle congestion (e.g., controlling traffic lights). As another example, the host 2002 may store surveillance video uploaded by a UE. As another example, the host 2002 may store or control access to media content such as video, audio, VR or AR which it can broadcast, multicast or unicast to UEs. As other examples, the host 2002 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2050 between the host 2002 and UE 2006, in response to variations in the measurement results. The measurement procedure and/or the network functionality for reconfiguring the OTT connection may be implemented in software and hardware of the host 2002 and/or UE 2006. In some embodiments, sensors (not shown) may be deployed in or in association with other devices through which the OTT connection 2050 passes; the sensors may participate in the measurement procedure by supplying values of the monitored quantities exemplified above, or supplying values of other physical quantities from which software may compute or estimate the monitored quantities. The reconfiguring of the OTT connection 2050 may include message format, retransmission settings, preferred routing etc.; the reconfiguring need not directly alter the operation of the network node 2004. Such procedures and functionalities may be known and practiced in the art. In certain embodiments, measurements may involve proprietary UE signaling that facilitates measurements of throughput, propagation times, latency and the like, by the host 2002. The measurements may be implemented in that software causes messages to be transmitted, in particular empty or ‘dummy’ messages, using the OTT connection 2050 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### Embodiments

1. A method performed in a user equipment, UE (1600) the method comprising:
observing (201, 401) a n−1th connection establishment failure, CEF, of a connection establishment procedure;
logging (203, 403) standardized information into an entry associated to the n−1th CEF in the CEF report list and starting a first timer t associated to the n−1th CEF;
observing (205, 405) a nth CEF of the connection establishment procedure;
determining (207, 407) if a first cell identifier for a cell where the nth CEF occurred and a second cell identifier for a cell where the n−1th CEF occurred are the same;
responsive to the first cell identifier and the second cell identifier being the same (409):
   replacing (209, 411) CEF information in the entry associated to the n−1th CEF in the CEF report list with the CEF information associated to the nth CEF; and
   starting (213, 215, 413) a second timer t associated to the n th CEF; and responsive to the first cell identifier and the second cell identifier not being the same:
   logging and appending (215, 415) CEF #n related information in the next entry of the CEF report list; and
   logging (215, 417) a current value of the timer t as the time since failure for the entry associated to the n−1 th CEF in the CEF report list.
      2. The method of Embodiment 1, wherein starting the second timer t comprises resetting a timer t associated to the n−1 th connection establishment failure and restarting the timer t for the associated n th connection establishment failure.
      3. The method of Embodiment 2, wherein resetting the timer t comprises resetting the timer t to zero.
      4. The method of Embodiment 1, further comprising:
responsive to the first cell identifier and the second cell identifier being the same: not logging (213, 501) the first timer t.
   5. The method of any of Embodiments 1-4, further comprising:
responsive to the first cell identifier and the second cell identifier not being the same:
   starting (215) a second timer t associated to the n th connection establishment failure.
      6. The method of Embodiment 5, wherein starting the second timer t comprises resetting a timer t associated to the n−1 th connection establishment failure and restarting the timer t for the associated n th connection establishment failure.
      7. The method of Embodiment 6, wherein resetting the timer t comprises resetting the timer t to zero.
      8. The method of any of Embodiments 1-7, further comprising:
receiving (217, 221, 601) a request from a network node to provide a CEF report; and
stopping (223, 603) timer t associated to a last CEF included in the CEF report list.
   9. The method of claim 8, further comprising:
logging (221, 605) the time since failure for the last entry of the CEF report list with a current value of timer t and reporting to the network.
   10. The method of Embodiment 8, further comprising:
setting (219, 223, 701) the time since failure for the rest of the entries of the CEF report list with a dummy value for the timer field within each entry and reporting to the network.
   11. The method of Embodiment 8, further comprising:
logging (801) the time since failure for the timer field within each entry of the CEF report list with a value of timer t and reporting to the network.
   12. A method performed in a user equipment, UE (1600) the method comprising:
observing (901) a n−1th connection establishment failure, CEF, of a connection establishment procedure;
logging (903) standardized information into an entry associated to the n−1th CEF in the CEF report list and starting a first timer tₙ₋₁ associated to the n−1th CEF;
observing (905) a nth CEF of the connection establishment procedure;
determining (907) if a first cell identifier for a cell where the nth CEF occurred and a second cell identifier for a cell where the n−1th CEF occurred are the same;
responsive (909) to the first cell identifier and the second cell identifier being the same and a first option is used:
   replacing (911) CEF information in the entry associated to the n−1th CEF in the CEF report list with the CEF information associated to the nth CEF; and
   performing (913) one of resetting and restarting the timer tₙ₋₁ or starting a second timer tₙ associated to the nth CEF; and
responsive (909) to the first cell identifier and the second cell identifier being the same and a second option is used:
   not logging (915) CEF information for the nth CEF; and
   continue (917) running the timer tₙ₋₁ associated to the n−1 th CEF;
responsive to the first cell identifier and the second cell identifier not being the same:
   continue (917) running the timer tₙ₋₁ associated to the n−1 th CEF.
      13. The method of Embodiments 12, further comprising:
responsive to the first cell identifier and the second cell identifier not being the same:
   logging and appending (1001) CEF #n related information in the next entry of the CEF report list; and
   starting (1003) a second timer tₙ associated to the n th CEF.
      14. The method of any of Embodiments 12-13, further comprising:
receiving (1101) a request from a network node (1700) to provide a CEF report; and
for each CEF included in the CEF report list, stopping (1103) the associated timer t.
   15. The method of Embodiment 14, further comprising:
updating (1105) each entry i in the CEF report list with a respective value of the corresponding timer tᵢ; and
report (1107) the CEF report list to the network.
   16. A method performed in a user equipment, the method comprising:
observing (1201) a first connection establishment failure, CEF, of a connection establishment procedure;
logging (1203) standardized information into an entry associated to the first CEF in the CEF report list and starting (1205) a timer t associated to the first CEF;
observing (1207) a nth CEF of the connection establishment procedure where n is greater than one;
logging (1207) standardized information into an entry associated to the nth CEF in the CEF report list and resetting (109) and restarting the timer t or starting an additional timer for the nth CEF;
receiving (1213) a request from a network node to provide a CEF report; and
responsive to receiving the request:
   stopping (1215) the timer t; and
   updating (1217) a last entry of the CEF report list with a value of the timer t.
      17. The method of Embodiment 16, further comprising:
updating (1301) remaining entries in the CEF report list with a value of timer tᵢ; and
reporting (1303) the CEF report list to the network.
   18. The method of Embodiment 16, further comprising:
updating (1401) remaining entries in the CEF report list with a dummy value for the timer field within each entry for the timer t; and
reporting (1403) the CEF report list to the network.
   19. The method of Embodiment 16, wherein updating remaining entries in the CEF report list with a dummy value for the timer field within each entry for the timer t comprises updating remaining entries for the timer field within each entry for the timer t in the CEF report list with a zero value.
   20. A user equipment, UE (1512A, 1512B, 1512C, 1512D, 1600, 1902, 2006) comprising: processing circuitry (1602); and
memory (1610) coupled with the processing circuitry, wherein the memory includes instructions that when executed by the processing circuitry causes the communication device to perform operations according to any of Embodiments 1-19.
   21. A user equipment, UE (1512A, 1512B, 1512C, 1512D, 1600, 1902, 2006) adapted to perform according to any of Embodiments 1-19.
   22. A computer program comprising program code to be executed by processing circuitry (1602) of a user equipment, UE (1512A, 1512B, 1512C, 1512D, 1600, 1902, 2006), whereby execution of the program code causes the UE (1512A, 1512B, 1512C, 1512D, 1600, 1902, 2006) to perform operations according to any of Embodiments 1-19.
   23. A computer program product comprising a non-transitory storage medium including program code to be executed by processing circuitry (1602) of a user equipment, UE (1512A, 1512B, 1512C, 1512D, 1600, 1902, 2006), whereby execution of the program code causes the UE (1512A. 1512B, 1512C. 1512D. 1600, 1902, 2006) to perform operations according to any of Embodiments 1-19.

### REFERENCES ARE IDENTIFIED BELOW

TS 37.320 Radio measurement collection for Minimization of Drive Tests (MDT); Overall description; Stage 2, v 16.7.0
TS 38.331 NR; Radio Resource Control (RRC); Protocol specification. V 16.7.0 R2-2204209 Introducing Enhancement of Data Collection for SON and MDT, rev 2 https://www.3gpp.org/ftp/tsg_ran/WG2_RL2/TSGR2_117-e/Inbox/R2-2204209.zip

1.-17. (canceled)

18. A method performed in a user equipment, UE, the method comprising:
observing a first connection establishment failure, CEF, of a connection establishment procedure;
logging standardized information into an entry associated to the first CEF in the CEF report list;
measuring a first time since failure associated with the first CEF;
observing one or more additional CEFs of the connection establishment procedure;
logging standardized information into one or more entries in the CEF report list, each of the one or more entries uniquely associated with the one or more additional CEFs;
measuring one or more additional times since failure, each of the one or more times since failure uniquely associated with a different one of the one or more additional CEFs;
receiving a request from a network node to provide a CEF report; and
responsive to receiving the request:
transmitting the CEF report and the CEF report list to the network node.

19. The method of claim 18, further comprising:
prior to transmitting the CEF report list, updating the CEF report list with entries for a value of the first time since failure and the one or more additional times since failure.

20. The method of claim 18, further comprising:
for each additional CEF of the one or more additional CEFs, determining if a first cell identifier for a cell where the first CEF occurred and a second cell identifier for a cell where the additional CEF occurred are the same;
responsive to the first cell identifier and the second cell identifier being the same:
not logging CEF information for the additional CEF; and
continue measuring the first time since failure associated to the first CEF; and
responsive to the first cell identifier and the second cell identifier not being the same:
continue measuring the first time since failure associated to the first CEF.

21. The method of claim 18, further comprising:
receiving a request from a network node to provide a CEF report; and
for each CEF included in the CEF report list, measuring a time since failure associated with the CEF.

22. The method of claim 18, further comprising:
updating each entry i in the CEF report list with a respective value of the corresponding time since failure; and
reporting the CEF report list to the network.

23. A user equipment, UE comprising:
processing circuitry; and
memory coupled with the processing circuitry, wherein the memory includes instructions that when executed by the processing circuitry causes the UE to perform operations comprising:
observe a first connection establishment failure, CEF, of a connection establishment procedure;
log standardized information into an entry associated to the first CEF in the CEF report list;
measure a first time since failure associated with the first CEF;
observe one or more additional CEFs of the connection establishment procedure;
log standardized information into one or more entries in the CEF report list, each of the one or more entries uniquely associated with the one or more additional CEFs;
measure one or more additional times since failure, each of the one or more times since failure uniquely associated with a different one of the one or more additional CEFs;
receive a request from a network node to provide a CEF report; and
responsive to receiving the request:
transmit the CEF report and the CEF report list to the network node.

24. The UE of claim 23, wherein the memory includes instructions that when executed by the processing circuitry causes the UE to perform operations further comprising:
prior to transmitting the CEF report list, update the CEF report list with entries for a value of the first time since failure and the one or more additional times since failure.

25. The UE of claim 23, wherein the memory includes further instructions that when executed by the processing circuitry causes the UE to perform operations further comprising:
for each additional CEF of the one or more additional CEFs, determine if a first cell identifier for a cell where the first CEF occurred and a second cell identifier for a cell where the additional CEF occurred are the same;
responsive to the first cell identifier and the second cell identifier being the same:
not log CEF information for the additional CEF; and
continue measuring the first time since failure associated to the first CEF; and
responsive to the first cell identifier and the second cell identifier not being the same:
continue measuring the first time since failure associated to the first CEF.

26. The UE of claim 23, wherein the memory includes further instructions that when executed by the processing circuitry causes the UE to perform operations further comprising:
receive a request from a network node to provide a CEF report; and
for each CEF included in the CEF report list, measure a time since failure associated with the CEF.

27. The UE of claim 23, wherein the memory includes further instructions that when executed by the processing circuitry causes the UE to perform operations further comprising:
update each entry i in the CEF report list with a respective value of the corresponding time since failure; and
report the CEF report list to the network.

28. A computer program product comprising a non-transitory storage medium including program code to be executed by processing circuitry of a user equipment, UE, whereby execution of the program code causes the UE to perform operations comprising:
observe a first connection establishment failure, CEF, of a connection establishment procedure;
log standardized information into an entry associated to the first CEF in the CEF report list;
measure a first time since failure associated with the first CEF;
observe one or more additional CEFs of the connection establishment procedure;
log standardized information into one or more entries in the CEF report list, each of the one or more entries uniquely associated with the one or more additional CEFs;
measure one or more additional times since failure, each of the one or more times since failure uniquely associated with a different one of the one or more additional CEFs;
receive a request from a network node to provide a CEF report; and
responsive to receiving the request:
transmit the CEF report and the CEF report list to the network node.
